(19) United States
(12) Patent Application Publication
(10) Pub. No.: US 2026/0138806 A1
(43) Pub. Date: May 21, 2026

(54) RECEIVING CONTAINER FOR A TWO-COMPONENT OR MULTI-COMPONENT CARTRIDGE AND TWO-COMPONENT OR MULTI-COMPONENT CARTRIDGE

(71) Applicant: RITTER GMBH, Schwabmuenchen (DE)

(72) Inventors: Dominik GEIGER, Hurlach (DE); Frank NOVAK, Bobingen (DE); Frank FINIS, Augsburg (DE); Stefan SCHMUTTERMAIR, Langerringen (DE)

(21) Appl. No.: 19/369,820

(22) Filed: Oct. 27, 2025

(30) Foreign Application Priority Data
Nov. 18, 2024 (DE) 10 2024 133 690.0

(51) Int. Cl. B65D 81/32; B01F 25/313; B01F 25/4314; B01F 35/00; B01F 35/71; B01F 101/00; B05C 17/005

(52) U.S. Cl. CPC B65D 81/325; B01F 25/3131; B01F 25/31331; B01F 25/43141; B01F 35/165; B01F 35/7164; B05C 17/00596; B01F 2101/2305

(57) ABSTRACT

A mixer element 4 which may be attached to a mouthpiece area 22 of a two-component cartridge is formed in one piece with a cover element 5. The cover element 5 closes an upper open side of a first wall section 201, which encloses an inner outlet volume of the mouthpiece area 22. A first filling substance of the cartridge passing the inner outlet volume is deflected by the cover element 5 and exits through radial openings 213 formed in the first wall section 201 into an outer outlet volume in order to mix with a second filling substance of the cartridge.

### TECHNICAL FIELD

This application relates to a receiving container for a two-component or multi-component cartridge for storing and dispensing plastic filling substances, comprising: a first chamber with a first volume for a first filling substance, which is enclosed by a first wall, a second chamber with a second volume for a second filling substance, which is enclosed by a second wall, a mouthpiece arrangement with a first wall section and a second wall section, the second wall section at least partially enclosing the first wall section, wherein the first wall section encloses a first, approximately cylindrical outlet volume, and the second wall section encloses a second, approximately annular outlet volume, wherein the first wall section is connected to the first wall and the second wall section is connected to the second wall. The application also refers to a two-component or multi-component cartridge comprising a receiving container as described above.

### STATE OF THE ART

In the prior art, a large number of two-component cartridges are known for storing and receiving plastic substances, such as sealants, adhesives, etc. Two-component cartridges have two chambers, each for holding a substance. The substances are kept separate during storage so that they cannot react with each other. The chambers may be arranged side by side (side-by-side cartridges) or inside each other, e.g., as coaxial chambers (coaxial cartridges). The inner chamber of coaxial cartridges usually has a cylindrical capacity, while the outer chamber has a ring-shaped capacity. The wall constructions are usually cylindrical tube bodies, one tube body coaxially inserted into the other tube body and fixed to each other in the mouthpiece area.

In the rear (proximal) area, the two tube bodies are closed by a cylindrical piston and a ring-shaped piston. Before use, the dual-chamber cartridge is closed by a cap located on a distal mouthpiece of the cartridge, which may also be used to reseal it during work interruptions.

In order to dispense the filling substances, the pistons are pushed forward, causing the substances to be dispensed through distal outlets of the inner and outer tube bodies. The outlets of the two chambers are formed by mouthpieces formed in the respective tube bodies, wherein the mouthpieces are connected to each other. Before dispensing substances from the cartridge, a mixing tube may be screwed onto the mouthpiece of the outer tube body, in which a mixer with axially successive mixing elements is arranged. The mixing tube has a distal opening through which the mixed substances may exit. The substances should be mixed as quickly and as homogeneously as possible so that a sufficiently homogeneous mixture exits the distal opening of the mixing tube.

On the other hand, the mixing system should be designed in such a way that the two filling substances may be mixed homogeneously with a mixing tube that contains as few mixing elements as possible and is as short as possible in order to reduce the required extrusion pressure. The greater the number of axially successive mixing elements in the mixing tube, the greater the required extrusion pressure, because each additional mixing element increases the flow resistance. This fact is all the more relevant the more viscous the substances to be extruded and mixed are.

In order to be able to design the mixer as short as possible and with as few mixing elements as possible, the two substances should already be divided into a plurality of flow strings in the mouthpiece arrangement, i.e., in the area of the chamber outlets, before they enter the inlet (proximal) area of the mixer tube and the mixer.

European publication no. EP 2 258 468 B1 shows an example of a mixing system in which a single, approximately cylindrical outlet channel of the mouthpiece part of the inner tube body widens at its outlet end in the form of a ring-like arrangement of several outwardly diverging pocket-like extensions. The extensions extend into the light cross-section of the outlet channel for the second material component defined by the outer tube body. The outlet channel for the second material component is arranged annularly around the outlet channel for the first material component. However, this design is complex in terms of manufacturing, as there are complex geometries with undercuts in the area of the chamber outlets.

### OBJECT OF THE INVENTION

The object of the present invention is to provide a receiving container or a two- or multi-component cartridge with simplified manufacturing technology, with good mixing properties for the filling substances united in the mouthpiece area of the cartridge, a corresponding cartridge, and a simplified method for the manufacture thereof.

### TECHNICAL SOLUTION

This object is attained by a receiving container according to any of claims 1 and 6, a two- or multi-component cartridge according to any of claims 10 and 15, and a method for manufacturing the two- or multi-component cartridge according to claim 18. Features of preferred embodiments of the invention are described in the dependent claims and the following description of the invention.

A receiving container for a two- or multi-component cartridge for storing and dispensing plastic filling substances according to the invention comprises:
a first chamber with a first volume for a first filling substance, which is enclosed by a first wall,
a second chamber with a second volume for a second filling substance, which is enclosed by a second wall, and
a mouthpiece arrangement with a first wall section and a second wall section, the second wall section enclosing at least partially the first wall section,
wherein the first wall section encloses a first, approximately cylindrical outlet volume, and the second wall section encloses a second, approximately annular outlet volume,
wherein the first wall section is connected to the first wall and the second wall section is connected to the second wall.

The arrangement according to the invention essentially consists of a first approximately cylindrical outlet channel/volume of the mouthpiece arrangement of the inner tube body and a second approximately annular outlet channel/volume of the mouthpiece arrangement of the outer tube body. Since the first outlet volume (as well as the second outlet volume) is open at the top (i.e., at the distal end of the wall sections), the mouthpiece arrangement is designed without undercuts. This makes it possible to manufacture the entire receiving container in one piece in a single injection molding tool. In order to nevertheless enable good premixing of the filling substances before they enter a downstream mixer, the first filling substance is deflected by a cover element axially covering the first outlet volume in the distal end region of the first wall section, for example by a cover element that forms a closure, deflection, or impact plate, configured either with or without a guide structure. The first filling substance thus enters a string of the second filling substance coming from the second chamber in a deflected manner with at least one radial component or transverse component through radial openings and openings providing a radial component of the string of the first substance, respectively.

The first and second walls are essentially designed as cylindrical shell walls. “Substantially cylindrical” or “approximately cylindrical” should be understood in the context of the invention to include shapes that are tubular with any cross-section and delimit a volume, i.e., variations of a cylindrical shape by means of changing the cross-section. The cross-section may vary axially as well.

“Above” and “from above” means viewed from the distal end relative to the flow direction of the filling substance. “Below” and “from below” means viewed from the proximal end relative to the flow direction of the filling substance.

At least one radial opening may be formed in the first wall section, which allows the first filling substance to exit from the first outlet volume into a string of the second filling substance with at least one radial component. Particularly, the at least one radial opening may be a recess formed in the first wall section. The recess extends from the distal edge of the first wall section towards the proximal end of the receiving container.

The arrangement and geometry of the radial openings allow strings of the first and second filling substances to be fed into each other and thus to be premixed in an optimized manner depending on the application.

The arrangement according to the invention enables a significant reduction in the number of mixing elements required in the mixing tube of the mixer to achieve a homogeneous mixing of the filling substances, as well as a reduction in the necessary extrusion pressure. Good premixing of the material strings of the filling substances is achieved due to the non-axial directional component of the first filling substance before the substances enter the mixer. The number of mixing elements required in the mixing tube for the subsequent mixing process until a (sufficiently) homogeneous mixture of the filling substances is achieved at the outlet opening of the mixing tube is reduced. In addition, the design according to the invention simplifies the manufacture of the receiving container and thus of the entire cartridge.

Preferably, the first wall section is essentially cylindrical and delimits a distal opening. The distal opening is essentially circular and corresponds to the diameter of the first outlet volume.

The receiving container is preferably designed as a single piece. The undercut-free design of the configuration of the mouthpiece of the container enables the production of a single-piece container in an injection molding process. As a result, at least the manufacturing step of joining the inner and outer tube bodies, which is required in the prior art, is eliminated.

The radial openings are preferably open toward the distal edge of the first wall section. This means that, when viewed from above, the radial openings are also formed in the first wall section without undercuts.

The first wall section may be formed with radial openings without undercuts, e.g., by means of the aforementioned upwardly open radial openings. During a moulding process, a tool, e.g., a core, which engages the cavity from above in order to form the openings, may thus be withdrawn during demolding without overcoming resistance due to undercuts and without impairing the end product.

While in the prior art the inner tube and the outer tube were manufactured in two parts and then joined together, the present invention allows the outer and inner tubes to be manufactured in one piece.

A cover element or a deflector or impact surface may be arranged at the upper opening of the first outlet volume and formed in one piece with the mixer. I.e. the mixer which may be attached to a mouthpiece area of a two-component receiving container may be formed in one piece with the cover element. The cover element closes an upper open side of the first wall section, which encloses an inner outlet volume of the mouthpiece area. A first filling substance of the cartridge passing the inner outlet volume is deflected by the cover element and exits through radial openings formed in the first wall section into an outer outlet volume in order to mix with a second filling substance of the cartridge.

Another receiving container for a two- or multi-component cartridge for storing and dispensing plastic filling substances according to the invention comprises:
a first chamber with a first volume for a first filling substance, which is enclosed by a first wall,
a second chamber with a second volume for a second filling substance, which is enclosed by a second wall,
a mouthpiece assembly with a first wall section and a second wall section,
wherein the first wall section is connected to the first wall and the second wall section is connected to the second wall,
an attachment connected to the first wall section, wherein the second wall section at least partially encloses the attachment, wherein the attachment comprises a jacket-like wall, at least one radial opening formed in the jacket-like wall, and a cover element, wherein the cover element is formed integrally with the jacket-like wall and closes a distal opening bounded by the jacket-like wall.

In this embodiment, the impact plate in the form of the cover element is formed integrally with the jacket-like wall as an attachment. The attachment may be optionally connected to the mixer.

In particular, the attachment may be connected to a connecting area of the first wall section, in particular by form fitting, in particular by clipping.

In particular, the attachment may be formed in one piece.

In all of the embodiments mentioned, the radial openings may have one of the following geometries: circular, as an elongated hole, in particular with a circular segment-like or pointed bottom area, triangular, dovetail-like, rectangular, with or without a structure, for example indentation, formed in the axial edges of the openings. The geometry and arrangement of the openings may be optimized depending on the application in order to achieve good premixing. For example, the geometry may be used to adjust the shape and surface of the exiting strings.

A two- or multi-component cartridge for storing and dispensing plastic filling substances according to the invention comprises:
a receiving container as described above, and
a cover element which is designed as a component separate from the receiving container and is designed to close a distal opening defined by the first wall section.

In a particular embodiment, the cover element may have at least one axial and/or radial and/or oblique passage opening (with both axial and radial components) for the passage of the first filling substance. This is particularly necessary if the first wall section does not have any radial passage openings. The passage openings may have suitable geometries, sizes, and arrangements.

A cover element may have geometries other than flat ones, e.g., a dome-like geometry. The cover element may have a (solid) body that forms an additional structure above the opening formed by the first wall section. Outlet openings may extend through the body.

The first wall section may be formed longer or shorter in height. In extreme cases, the first wall section may consist solely of the edge of the outlet opening of the first chamber.

A cover element may be formed in one piece with the upper edge of the first wall section, e.g., in the form of tabs which are then folded inwards over the opening formed by the first wall section and fastened (e.g., to each other) in such a way that they at least partially close the opening defined by the first wall section.

According to an aspect of the present invention the cartridge is used to dispense mixed filling substances. For better pre-mixing the cover element rests on the central tube body or is connected to it (e.g., clipped, snapped, formed integrally, etc.) and closes the distal opening. The geometry of the radial openings, which are preferably open towards the distal opening defined by the first wall section, may be selected relatively flexibly. In addition, the cover element may be designed with guiding elements, guide webs, and/or baffles to optimize the material strings and their flow direction. In particular, the cover element may be formed in one piece with the mixer.

In summary, an impact element (e.g. impact plate) is assigned to the central area of the mouthpiece part associated with the inner tube body in the area of the distal opening thereof. The impact element covers the central area of the cylindrical outlet volume, so that the first filling substance emerging from the interior of the first tube body flows radially past the impact plate through the radial openings outwards into the second outlet volume, thereby forming a plurality of material strings.

The two- or multi-component cartridge may furthermore comprise a mixing tube attachable to the mouthpiece assembly and a mixer.

In a preferred embodiment of the invention, the cover element is connected to the mixer.

In particular, the cover element may be formed integrally with the mixer.

Another two- or multi-component cartridge for storing and dispensing plastic filling substances according to the invention comprises:
a receiving container comprising
a first chamber with a first volume for a first filling substance, which is enclosed by a first wall,
a second chamber with a second volume for a second filling substance, which is enclosed by a second wall,
a mouthpiece arrangement with a first wall section and a second wall section,
wherein the first wall section is connected to the first wall and the second wall section is connected to the second wall, and
an attachment connected to the first wall section, wherein the second wall section at least partially encloses the attachment, wherein the attachment comprises a jacket-like wall, at least one radial opening formed in the jacket-like wall, and a cover element, wherein it is preferred that the cover element is formed integrally with the jacket-like wall, and wherein the cover element closes a distal opening defined by the jacket-like wall. The attachment may be, for example, a cap.

In all embodiments of the invention, the cover element may be designed as a deflection element and/or impact plate for radially deflecting a stream of the first filling substance.

The cover element may have at least one of the following geometries on its proximal side: flat, plane, perpendicular to the first wall section or to the jacket-like wall; concave; convex; circular segment-like (concave, convex); curved; with a guide structure, e.g. with guide elements, e.g., guide webs, guide ribs, with straight, oblique, and/or serpentine configuration.

A method for manufacturing a two- or multi-component cartridge according to the invention comprises at least the following steps:
(a) in a first injection molding process: production of a receiving container as described above in one piece; and
(b) in a further injection molding process: production of a mixer with an associated cover element.

Before use, the mixer with the cover element is attached to the receiving container, for example, may be brought in contact and/or fastened to the first wall section of the receiving container.

The invention may be used both for the provision of coaxial cartridges and for the provision of side-by-side cartridges.

### BRIEF DESCRIPTION OF THE DRAWINGS

The invention is illustrated by the drawings and the following description of the figures. For example, the figures shoe

FIG. 1 an axial sectional view of a nozzle area of a two-component cartridge according to the invention with a mixer and mixing tube arranged on the nozzle;

FIG. 2a a perspective view of a first embodiment of a nozzle area of a two-component cartridge according to the invention with a mixer arranged on the nozzle;

FIG. 2b an axial sectional view of the mouthpiece area of FIG. 2a;

FIG. 3a a perspective view of a second embodiment of a mouthpiece area of a two-component cartridge according to the invention with a cover element arranged on the mouthpiece;

FIG. 3b an axial sectional view of the mouthpiece area of FIG. 3a;

FIG. 4a a perspective view of a mixer according to a first variant of FIGS. 2a, 2b and 3a, 3b;

FIG. 4b an axial sectional view of the mouthpiece area of FIG. 4a;

FIG. 5a a perspective view of a mixer according to a second variant of FIG. 2a, 2b or 3a, 3b;

FIG. 5b an axial sectional view of the mouthpiece area of FIG. 5a;

FIG. 6a a perspective view of a mixer according to a third variant of FIG. 2a, 2b or 3a, 3b;

FIG. 6b an axial sectional view of the mouthpiece area of FIG. 6a;

FIG. 7a a perspective view of a third embodiment of a mouthpiece area of a two-component cartridge according to the invention;

FIG. 7b an axial sectional view of the mouthpiece area of FIG. 7a;

FIG. 8a a perspective view of a fourth embodiment of a mouthpiece area of a two-component cartridge according to the invention with a cover element arranged on the mouthpiece;

FIG. 8b an axial sectional view of the mouthpiece area of FIG. 8a;

FIG. 9a a perspective view of a fifth embodiment of a mouthpiece area of a two-component cartridge according to the invention with a cover element arranged on the mouthpiece;

FIG. 9b an axial sectional view of the mouthpiece area of FIG. 9a;

FIG. 10a a perspective view of a sixth embodiment of a mouthpiece area of a two-component cartridge according to the invention with a cover element arranged on the mouthpiece;

FIG. 10b an axial sectional view of the mouthpiece area of FIG. 10a;

FIG. 11a a perspective view of a seventh embodiment of a mouthpiece area of a two-component cartridge according to the invention with a cover element arranged on the mouthpiece;

FIG. 11b an axial sectional view of the mouthpiece area of FIG. 11a;

FIG. 12a a perspective view of an eighth embodiment of a mouthpiece area of a two-component cartridge according to the invention with a cover element arranged on the mouthpiece;

FIG. 12b an axial sectional view of the mouthpiece area of FIG. 12a;

FIG. 13a an axial sectional view of a ninth embodiment of a mouthpiece area of a two-component cartridge according to the invention with a cover element arranged on the mouthpiece;

FIG. 13b a perspective view of the mouthpiece area of FIG. 13a;

FIG. 14a an axial sectional view of a tenth embodiment of a mouthpiece area of a two-component cartridge according to the invention with a cover element arranged on the mouthpiece;

FIG. 14b a perspective view of the mouthpiece area of FIG. 14a;

FIG. 15a an axial sectional view of an eleventh embodiment of a mouthpiece area of a two-component cartridge according to the invention with a cover element arranged on the mouthpiece;

FIG. 15b a perspective view of the mouthpiece area of FIG. 15a;

FIG. 16a a perspective view of a twelfth embodiment of a mouthpiece area of a two-component cartridge according to the invention with a cover element in a first state;

FIG. 16b the perspective view of FIG. 16a in a second state;

FIG. 17a-17c views of a thirteenth embodiment of the invention;

FIG. 18 is an axial sectional view of a coaxial cartridge;

FIG. 19 is an axial sectional view of a side-by-side cartridge.

### DESCRIPTION OF PREFERRED EMBODIMENTS OF THE INVENTION

In the figures, identical or corresponding elements are designated by the same reference numerals.

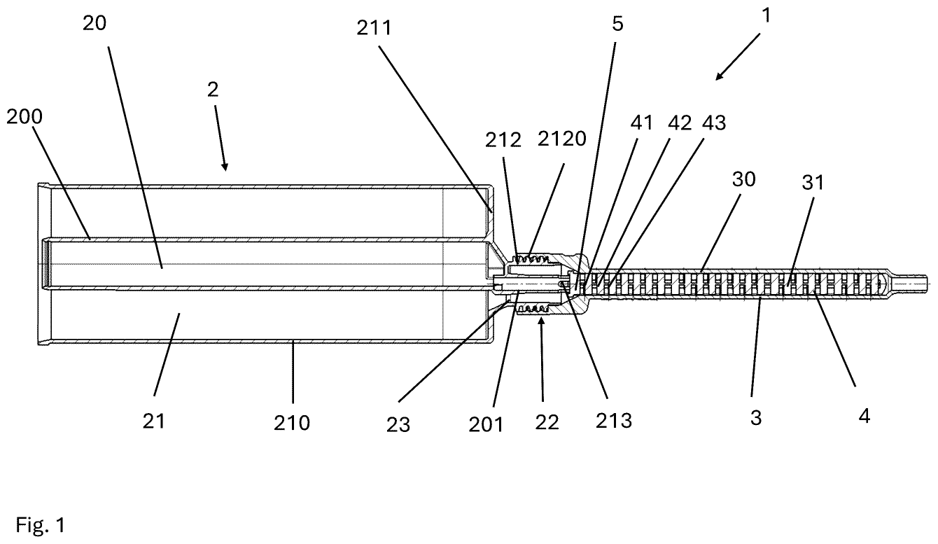

FIG. 1 shows an axial sectional view of the mouthpiece area of a two-component cartridge 1 according to the invention.

The cartridge 1 has a receiving container 2 for two different substances with a first inner, substantially cylindrical chamber 20 for a first filling substance, and a second outer, substantially annular chamber 21 for a second filling substance.

A first cylindrical wall 200 of the inner first chamber 20 is formed as a first tube body which delimits a proximal first volume. The wall 200 separates the first chamber 20 from the second chamber 21. In the distal opening area 22, the first tube body has a first wall section 201 which delimits a distal first outlet volume which has a smaller radius than the proximal first volume. Radial openings 213 are formed in the first wall section 201, through which the first filling substance may pass during dispensing of the substances with a radial flow component and mix with the second filling substance coming from below from the second chamber 21.

The second chamber 21 is designed as a cylindrical tube body. A second cylindrical wall 210 delimits a proximal annular second volume. The second wall 210 delimits the volume of the second chamber 21 towards the outside. The second wall 210 transitions into an end wall 211. The end wall 211 is connected to a distal cylindrical second wall section 212, which delimits a distal second outlet volume that has a smaller radius than the proximal second volume. An external thread 2120 is formed on the outside of the second wall section 212 for connecting or screwing on a mixing tube 3.

The proximal first wall 200 is arranged concentrically with the proximal second wall 210. The space defined by the proximal first wall 200 has a smaller radius than the space defined by the proximal second wall 210. The distal first wall section 201 is arranged concentrically with the distal second wall section 212. The space enclosed by the distal first wall section 201 has a smaller radius than the space enclosed by the distal second wall section 212.

A connecting element 23 is arranged between the wall sections 201 and 212, connecting the first tube body 20 to the second tube body 21. The connecting element 23 has one or more webs extending radially between the wall sections 201 and 212, the webs being spaced in the circumferential direction, between which axial openings are provided for the passage of the second filling substance during the dispensing of the substances. In particular, the first tube body and the second tube body are designed as a single piece.

An opening area 22 of the receiving container 2 essentially consists of the wall sections 201 and 212. In the opening area 22, in particular on the outside of the second wall section 212, a mixing tube 3 is screwed on before the cartridge 1 is used. The mixing tube 3 is a tubular body with a proximal connecting section 30, a cylindrical inner volume 31, and a distal outlet opening. A mixer 4 is arranged in the cylindrical inner volume 31. The mixer 4 has a series of mixing elements 41, 42, 43, . . . arranged axially one behind the other, which repeatedly twist and divide the strings of material passing through the mixing tube 3, thereby effecting mixing.

A (separate) cover element 5 is arranged on the upper open side of the first wall section 201, which closes the mouth opening of the first wall section 201. The cover element 5 ensures that the substance flowing out of the first chamber 20 is deflected and exits through the radial openings 213. The flow direction of the first substance has at least one radial component. In the intermediate area between the wall sections 201 and 212 or immediately outside the openings 213 and below, at the level and/or above the mouth opening of the second wall section 212, the filling substances mix before they enter the area of the mixer 4 (guided by the wall of the mixing tube 3). The cover element 5 may be designed as a separate component, or, as in the present embodiment, it may be connected to the mixer 4 or formed integrally with the mixer 4.

Due to its design, the receiving container 2 may be formed as a single piece with the first tube body and the second tube body, whereby the tube bodies are connected by the connecting element 23, whereas in the prior art, the tube bodies are manufactured separately and joined together after manufacture, e.g., by clipping them together.

In contrast, in the present invention, in a first step of manufacturing the cartridge 1 according to the invention, the receiving container 2 is manufactured in one piece in an injection molding process.

In a further step of the process, a mixer 4 with the associated cover element 5 is manufactured in a further injection molding process. The order of the process steps is irrelevant.

Before using the cartridge 1, the cover element 5 (which is integrally formed with the mixer 4) is attached to the mouth opening of the first wall section 201 by the user and the mixing tube 3 is screwed onto the mouth area 22, in particular onto the outside of the second wall section 212 (which may be threaded), over the mixer 4 accommodated therein. Alternatively, the mixer 4 with the one-piece (integral) cover element 5 is inserted into the mixing tube 3 and the mixing tube 3 with the mixer 4 and cover element held therein is screwed onto the mouth area 22, in particular onto the outside of the second wall section 212. When screwed on, the cover element 5 closes the mouth opening of the first wall section 201.

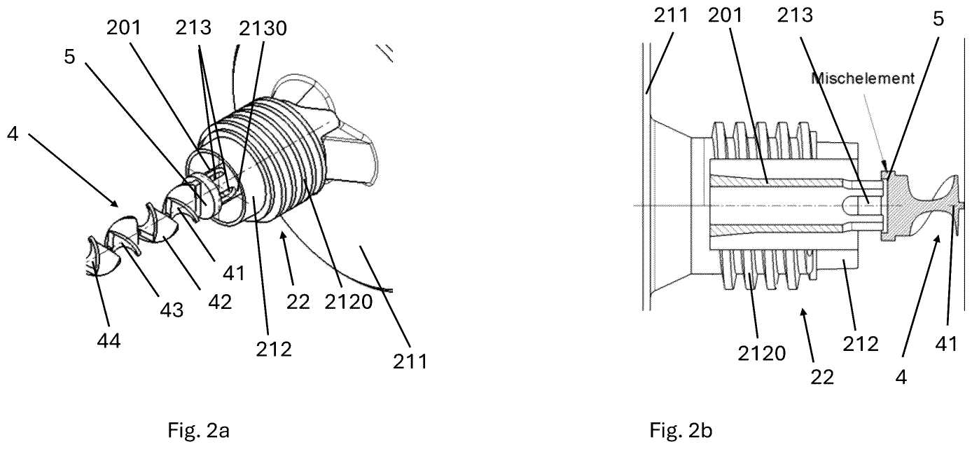

FIGS. 2a and 2b show a first embodiment of a mouthpiece area 22 of a two-component cartridge 1 according to the invention with a mixer 4 arranged on the mouthpiece 22. The mixer 4 is formed in one piece with the cover element 5. The cover element 5 closes the upper open side of the first wall section 201. The filling substance from the first chamber 20 is deflected by the cover element 5 and exits through the radial openings 213. The radial openings 213 (in this case four or an even number) are evenly distributed around the upper edge of the first wall section 201. The radial openings 213 are open at the top and extend downwards as long slots. The bottom 2130 of the elongated openings is concave (viewed from above) with a semicircular geometry. In particular, the mouthpiece 22 has no undercuts in the distal end region, so that the receiving container 2 may be manufactured with the mouthpiece region 22 as a one-piece component by injection molding.

The cover element 5 is designed as the proximal section of a complemented mixing element 4.

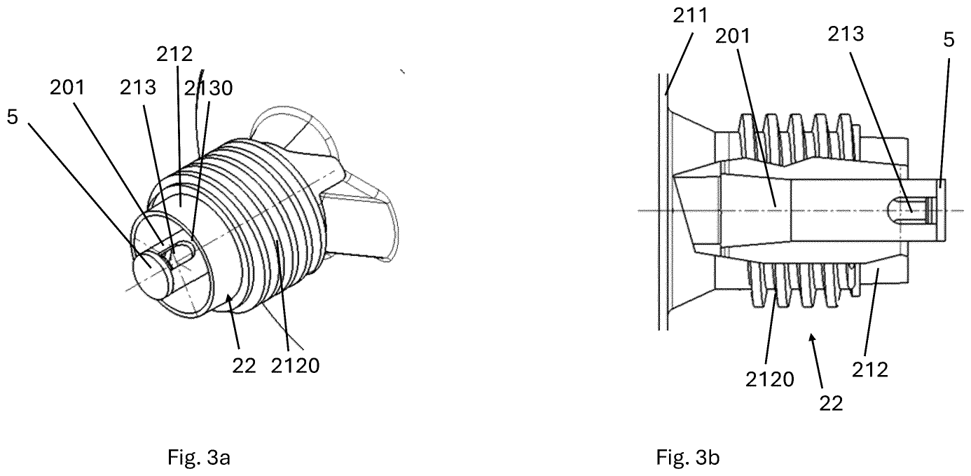

FIGS. 3a and 3b show a second embodiment of a mouthpiece area 22 of a two-component cartridge 1 according to the invention. The second embodiment substantially corresponds to the first embodiment.

A cover element 5 is arranged on the mouthpiece 22. The cover element 5 is either formed as a separate component and/or connected to the mixer 4. Usually, however, in order to save moulding and fixing steps, the cover element 5 is formed as an integral part of the mixer 4. The cover element 5 closes the upper open side of the first wall section 201. The radial openings 213 (in this case three or an odd number) are evenly distributed around the upper edge of the first wall section 201. The form of the radial openings 213 is designed as in the first embodiment.

In the second embodiment, the cover element 5 is locked onto the upper edge of the first wall section 201. The cover element 5 may have different outlet geometries. As in the first embodiment, a mixer (not shown) formed in one piece with the cover element may be connected to the cover element. This also applies to all embodiments and variants described below.

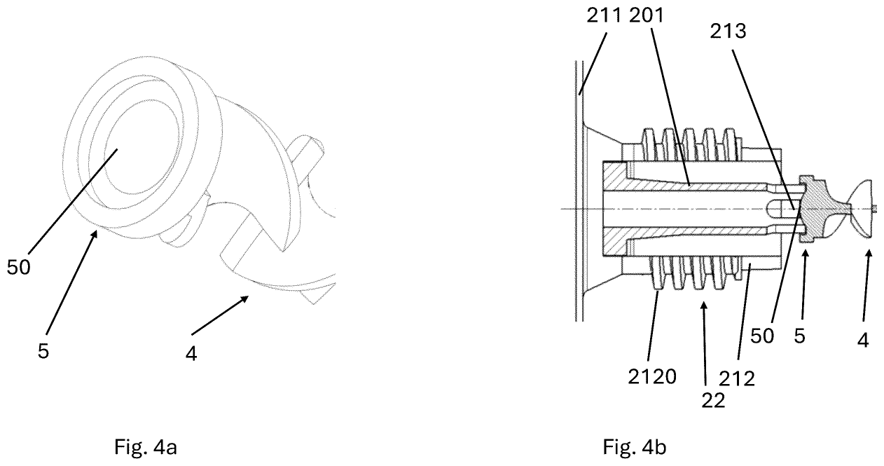

FIGS. 4a and 4b show a first variant of the first embodiment and the second embodiment, respectively, of the invention. FIG. 4a shows a mixer 4 with a cover element 5 connected thereto. The cover element 5 has an inner (proximal) deflection surface or impact surface 50, which (viewed from below) is convex in the shape of a spherical segment. The impact surface 50 deflects the substance flowing toward the openings 213 in a desired flow direction so that the first filling substance is premixed with the second filling substance as effectively as possible in the mixing area outside the openings 213.

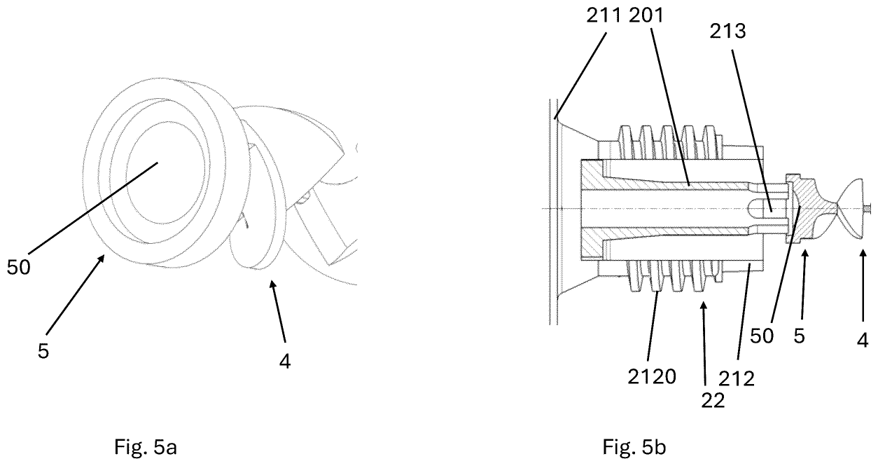

In a further variant according to FIGS. 5a and 5b, the cover element 5 has an inner (proximal) deflection surface or impact surface 50 which (viewed from below) is concave in the shape of a spherical segment. The flow path to the openings 213 is stretched by the concave geometry of the impact surface 50.

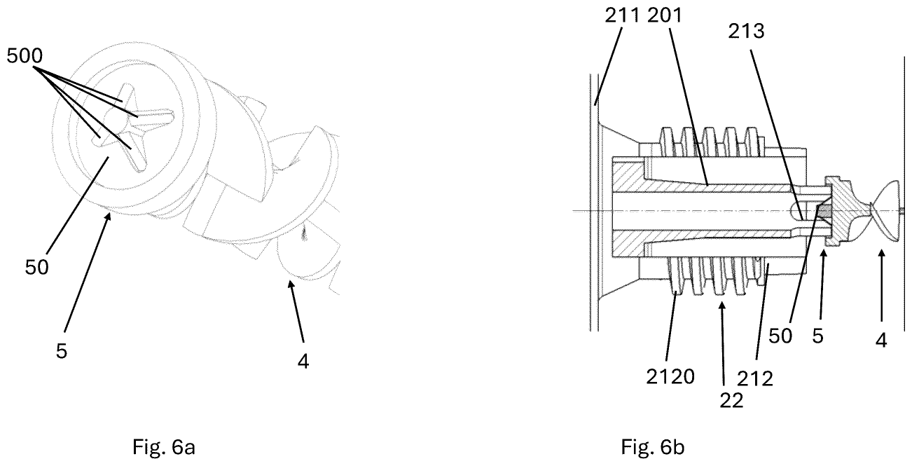

In a further variant according to FIGS. 6a and 6b, the cover element 5 has an inner (proximal) deflection surface or impact surface 50 which is provided with guide ribs 500. In principle, guide ribs may take any shape (e.g., straight, oblique, curved in any directions, etc.) that optimizes the flow path or flow direction for a specific combination of substances.

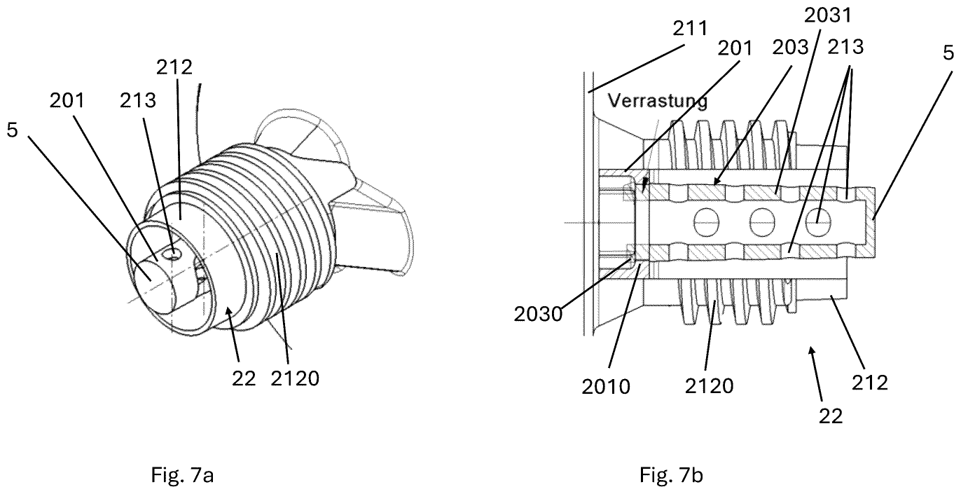

The mouthpiece areas 22 of further embodiments of the invention shown in FIGS. 7a and 7b, 8a and 8b, 9a and 9b, 10a and 10b, 11a and 11b, and 12a and 12b differ from the first embodiment and the second embodiment in the arrangement and geometry of the passage openings 213 formed in the first wall section 201.

In a third embodiment according to FIGS. 7a and 7b, the first wall section 201 is shortened and has a connecting area 2010 with an undercut. An attachment 203 is arranged in the area of the distal end of the first wall section 201 and is connected to the first wall section 201, e.g., clipped on it. The attachment 203 has a connecting area 2030 which is connected, for example clipped, to the connecting area 2010 of the first wall section 201. The attachment 203 has a cylindrical shell wall 2031 and a cover element 5 formed integrally with the shell wall 2031. Several (different numbers are possible, even and odd numbers) radial openings 213, in this example formed as round holes, but not limited to these, are formed in the shell wall 2031. The distribution of the openings 213 on the shell surface 201 may be symmetrical and/or asymmetrical.

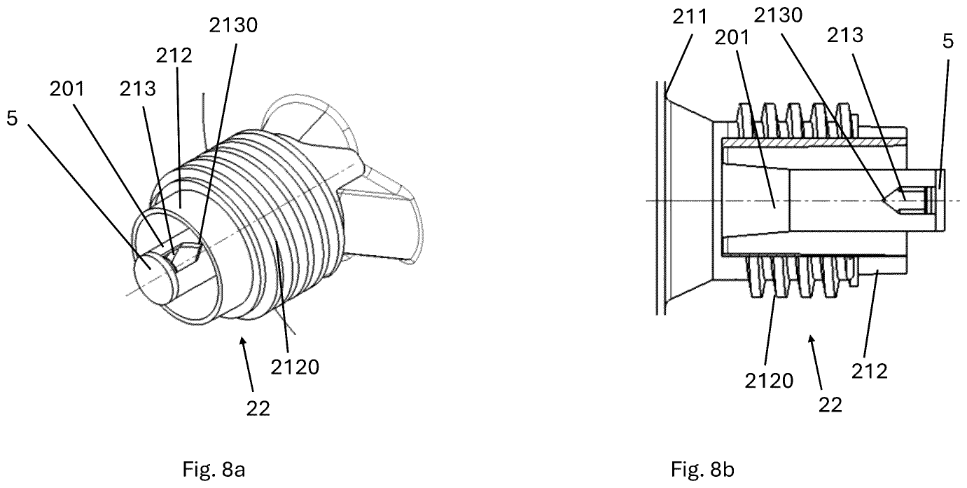

In a fourth embodiment according to FIGS. 8a and 8b, the openings 213 are formed as long slots, but, unlike in the first and second embodiments, with a tapered bottom 2130.

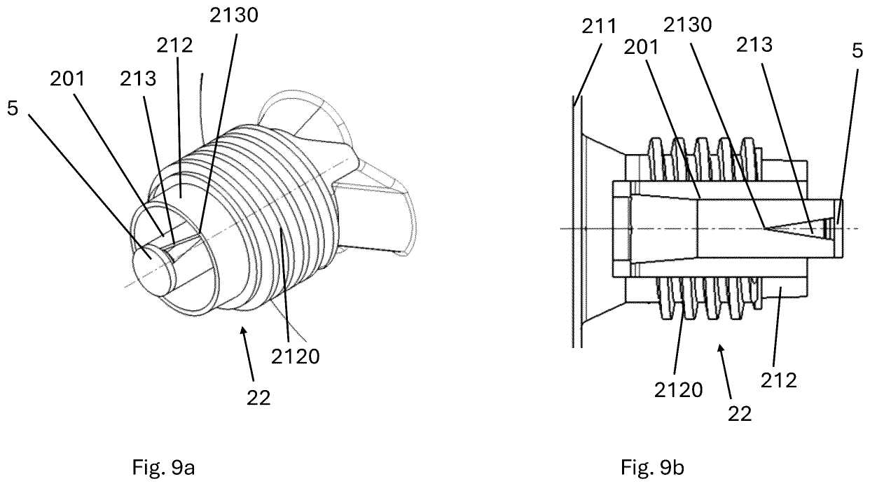

In a fifth embodiment according to FIGS. 9a and 9b, the openings 213 are formed as triangles open at the upper edge of the first wall section 201, wherein the edges of each of the triangles meet at a point 2130 at the bottom.

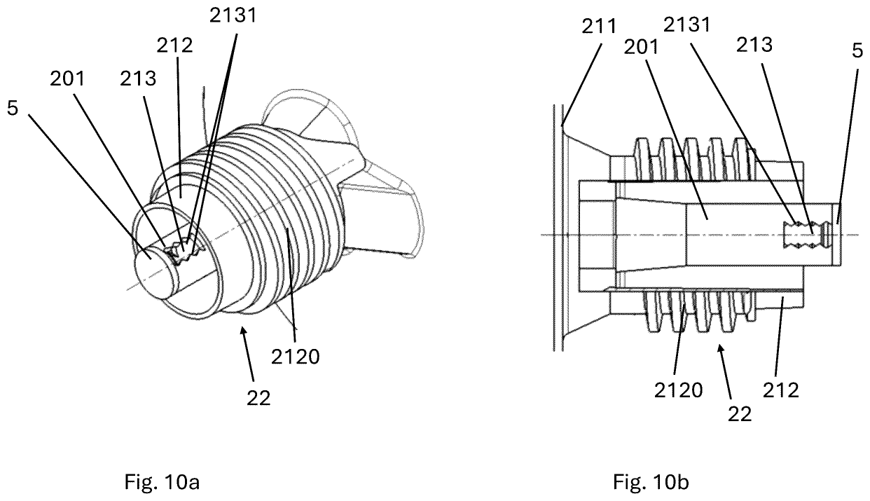

In a sixth embodiment according to FIGS. 10a and 10b, the openings 213 are rectangular and open towards the upper edge of the first wall section 201. The axial edges 2131 of the openings 213 are provided with a structure, e.g. serrations. The serrations 2131 provide a larger surface area for the material string pressed through the openings 213 and may thus lead to better premixing of the filling substances.

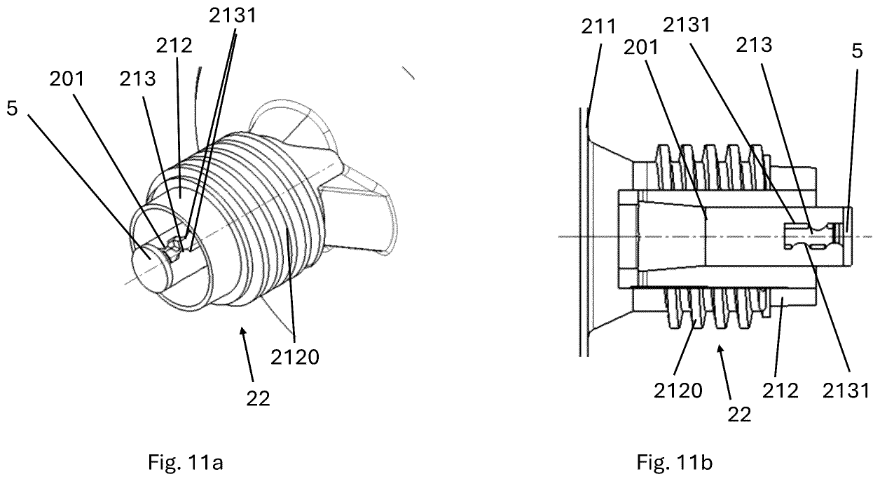

In a seventh embodiment according to FIGS. 11a and 11b, one or more openings 213 consist of rectangles arranged in a row and offset in the circumferential direction with serrated and/or offset teeth on the axial edges 2131. The openings 312 are open to the upper edge of the first wall section 201. The cover element 5 forms the upper edge of the openings 213.

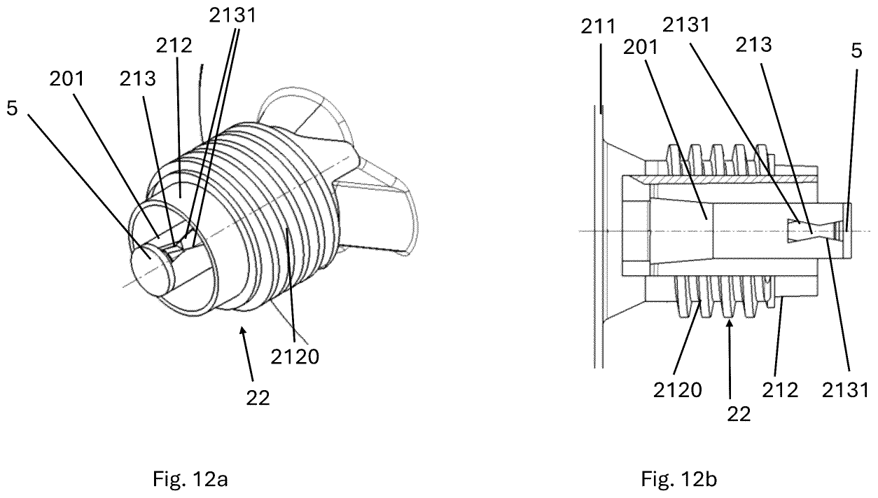

In an eighth embodiment according to FIGS. 12a and 12b, one or more openings 213 consist of two trapezoidal cutouts, the shorter bases of which are of equal length and lie next to each other, so that an opening 213 with a sloping inlet on both sides is created. The shape of the openings 213 after attachment of the cover element 5 corresponds to two symmetrically joined dovetail geometries.

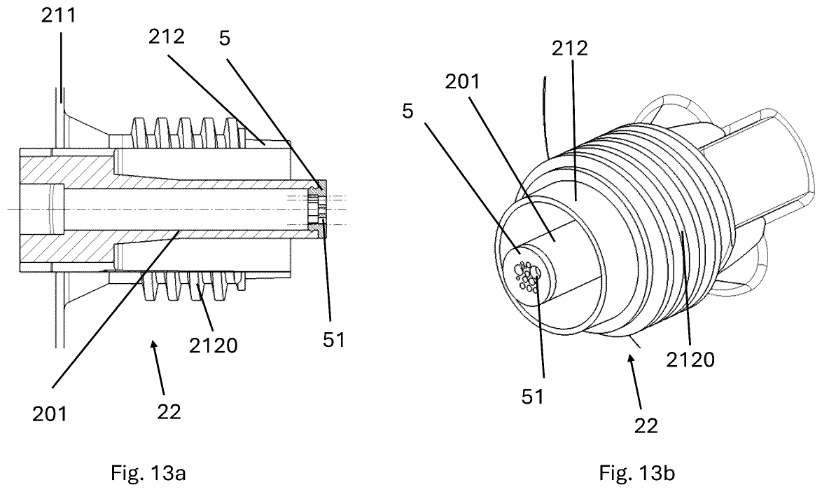

FIGS. 13a and 13b show a ninth embodiment of a mouthpiece area 22 of a two-component cartridge according to the invention with a cover element 5 arranged on the mouthpiece 22. Unlike in the embodiments described above, there are no radial openings in the first wall section 201, but rather axial openings 51 in the cover element 5. In this embodiment, the cover element 5 is clipped onto the first wall section 201. The axial outlets are formed with partially different diameters and, if necessary, with an uneven arrangement.

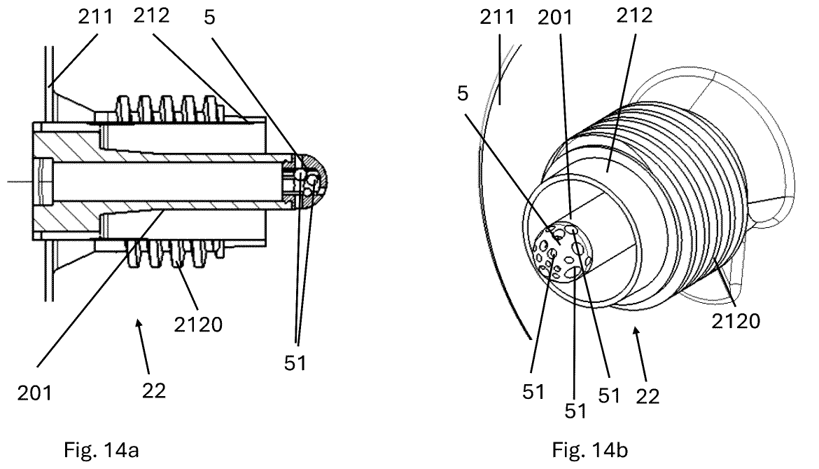

FIGS. 14a and 14b show a tenth embodiment of a mouthpiece area 22 of a two-component cartridge according to the invention with a cover element 5 arranged on the mouthpiece 22. Unlike in the ninth embodiment, the cover element 5 is dome-shaped with axial, radial, and oblique (i.e., with axial and radial components) openings 51.

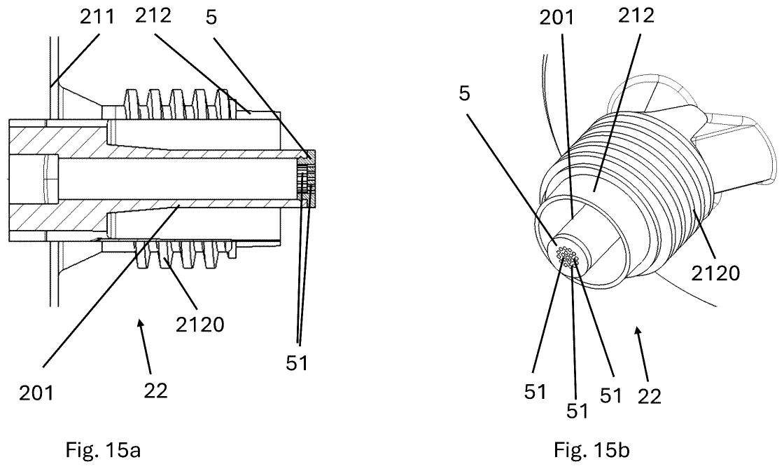

FIGS. 15a and 15b show an eleventh embodiment of a mouthpiece area 22 of a two-component cartridge according to the invention with a cover element 5 arranged on the mouthpiece 22. Unlike in the ninth embodiment, however, the axial openings 51 are arranged in a uniform arrangement and are formed with equal diameters.

Combinations of embodiments nine to eleven are possible within the scope of the invention.

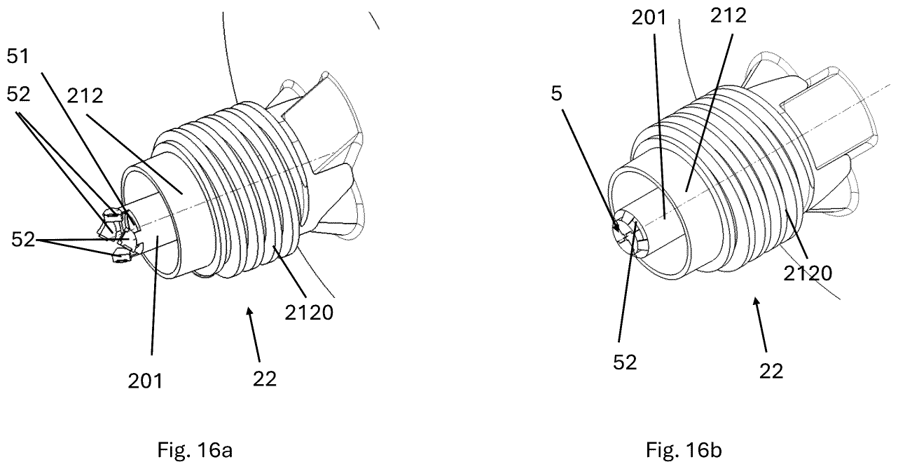

FIGS. 16a and 16b show a twelfth embodiment of a mouthpiece area 22 of a two-component cartridge according to the invention with a cover element 5 arranged on the mouthpiece 22. In this embodiment, the cover element 5 is formed in one piece with the first wall section 201. FIG. 16a shows the state after injection molding. The cover element 5, consisting of tabs 52, is injection molded in one piece with the cartridge. In this first state the tabs 52 extend substantially axially forward from the upper edge of the first wall section 201. In a second state the tabs 52 are bent inward and clipped together to form a substantially axial closure 5. The cover element 5 and the first wall section 201, respectively, have radial openings 51. The openings may as well be axial or oblique.

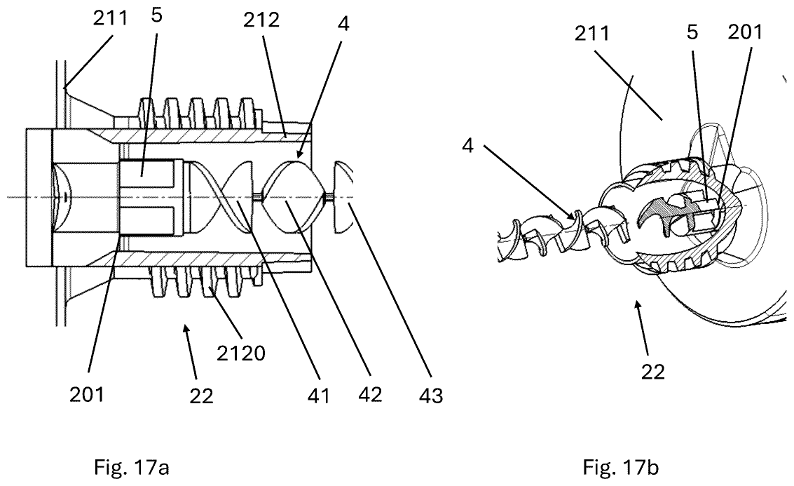

FIGS. 17a to 17c show a twelfth embodiment of a mouthpiece area 22 of a two-component cartridge according to the invention with a cover element 5 arranged on the mouthpiece 22. Unlike in the embodiments described so far, the cover element 5, with which a mixer 4 is formed in one piece, is mounted on the outlet of the first cylindrical wall 200. The first wall section 201 is only rudimentary or forms the edge of the opening of the first chamber 20. The cover element 5 is provided with at least one axial opening.

FIG. 17c shows a section of the combination of the integrated cover element 5 and mixer 4. The combination element 4, 5 is clipped onto the edge of the opening of the first chamber 20 via a step 53. The first filling compound first exits axially through passages 54 and is deflected laterally radially by the baffle plate 55 to the second filling compound arriving from the second chamber 21. The combined strings are fed to the mixer 4 (usually through a mixing tube).

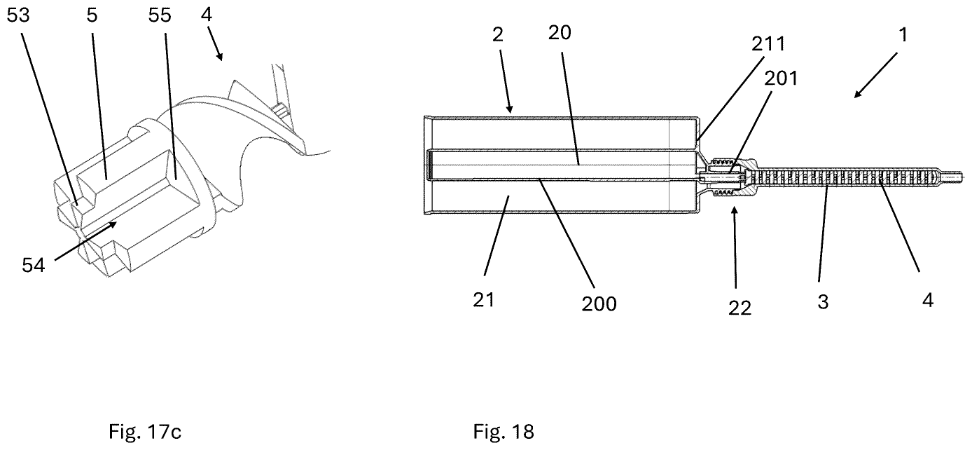

FIG. 18 schematically shows a coaxial cartridge 1 with a corresponding receiving container 2, in which the chambers 20, 21 are arranged one inside the other, with a mixing tube 3 and mixer 4. In this design, a mouthpiece arrangement 22 as described above, possibly with a cover element 5, may be integrated. It is clear that the container 2 may be manufactured in one piece.

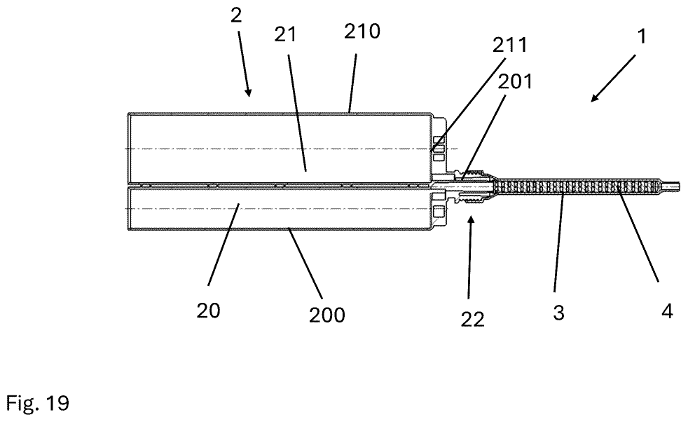

FIG. 19 schematically shows a side-by-side cartridge 1 with a corresponding receiving container 2, in which the chambers 20, 21 are arranged adjacent to each other, with a mixing tube 3 and mixer 4. In this design a mouthpiece arrangement 22 as described above, possibly with a cover element 5, may be integrated. It is clear that the container 2 may be manufactured in one piece.

The features described for the different embodiments may be combined in any variant within the scope of this disclosure, as far as it is technically feasible.

1. A receiving container for a two- or multi-component cartridge for storing and dispensing plastic filling substances, comprising:
a first chamber with a first volume for a first filling substance, which is enclosed by a first wall,
a second chamber with a second volume for a second filling substance, which is enclosed by a second wall, and
a mouthpiece arrangement with a first wall section and a second wall section, the second wall section at least partially enclosing the first wall section,
wherein the first wall section encloses a first approximately cylindrical outlet volume, and the second wall section encloses a second approximately annular outlet volume,
wherein the first wall section is connected to the first wall and the second wall section is connected to the second wall,
wherein the receiving container is formed in one piece.

2. The receiving container for a two- or multi-component cartridge according to claim 1, wherein the first wall section is essentially cylindrical and defines a distal opening.

3. The receiving container for a two- or multi-component cartridge according to claim 1, wherein at least one radial opening is formed in the first wall section that allows the first filling substance to exit from the first outlet volume into a string of the second filling substance flowing through the second outlet volume with at least one radial component.

4. The receiving container for a two- or multi-component cartridge according to claim 3, wherein the radial openings are recesses in the first wall section which are open at the distal edge of the first wall section.

5. The receiving container for a two- or multi-component cartridge claim 1, wherein the first wall section is formed with radial openings without undercuts.

6. A receiving container for a two- or multi-component cartridge for storing and dispensing plastic filling substances, comprising:
a first chamber with a first volume for a first filling substance, which is enclosed by a first wall,
a second chamber with a second volume for a second filling substance, which is enclosed by a second wall, and
a mouthpiece assembly with a first wall section and a second wall section,
wherein the first wall section is connected to the first wall and the second wall section is connected to the second wall,
an attachment connected to the first wall section, the second wall section at least partially enclosing the attachment, wherein the attachment comprises a jacket-like wall, at least one radial opening formed in the jacket-like wall, and a cover element, wherein the cover element is formed integrally with the jacket-like wall and closes a distal opening defined by the jacket-like wall.

7. The receiving container for a two- or multi-component cartridge according to claim 1, wherein the radial openings have one of the following geometries: circular, elongated, in particular with a circular segment-shaped or pointed bottom area, triangular, dovetail-shaped, rectangular, with or without a structure, for example indentations in the axial edges of the openings.

8. The receiving container for a two- or multi-component cartridge according to claim 6, wherein the radial openings have one of the following geometries: circular, elongated, elongated with a circular segment-shaped or pointed bottom area, triangular, dovetail-shaped, rectangular, with or without a structure.

9. The receiving container for a two- or multi-component cartridge according to claim 6, wherein the attachment is connected to a connecting area of the first wall section.

10. The receiving container for a two- or multi-component cartridge according to claim 6, wherein the attachment is formed in one piece.

11. A two- or multi-component cartridge for storing and dispensing plastic filling substances, comprising:
a receiving container according to claim 1, and
a cover element which is configured as a component separate from the receiving container and is configured to close a distal opening defined by the first wall section.

12. The two- or multi-component cartridge for storing and dispensing plastic filling substances according to claim 11, wherein the cover element has at least one of an axial and a radial and an oblique passage opening for the passage of the first filling substance.

13. The two- or multi-component cartridge for storing and dispensing plastic filling substances according to claim 11, wherein the two- or multi-component cartridge further comprises: a mixing tube that may be attached to the mouthpiece assembly; and a mixer.

14. The two- or multi-component cartridge for storing and dispensing plastic filling substances according to claim 13, wherein the cover element is connected to the mixer.

15. The two- or multi-component cartridge for storing and dispensing plastic filling substances according to claim 13, wherein the cover element is formed in one piece with the mixer.

16. A two- or multi-component cartridge for storing and dispensing plastic filling substances, comprising:
a receiving container according to claim 6.

17. The two- or multi-component cartridge for storing and dispensing plastic filling substances according to claim 11, wherein the cover element is configured as at least one of a deflection element and an impact element for radially deflecting a string of the first filling substance.

18. The two- or multi-component cartridge for storing and dispensing plastic filling substances according to claim 11, wherein the cover element has at least one of the following geometries at its proximal side: flat, planar, perpendicular to the first wall section or to the jacket-like wall; concave; convex; circular segment-like, concave, convex; curved; with a guide structure, with guide elements.

19. A method for manufacturing a two- or multi-component cartridge, comprising at least the following steps:
(a) manufacturing the receiving container according to claim 1 in one piece in an injection molding process; and
(b) manufacturing a mixer with a cover element connected thereto in a further injection molding process.
